(19) United States
(12) Patent Application Publication
(10) Pub. No.: US 2004/0072976 A1
(43) Pub. Date: Apr. 15, 2004

(54) Low dielectric constant materials from plant oils and chicken feathers

(75) Inventors: Richard P. Wool, Newark, DE (US); Chang K. Hong, Newark, DE (US)

Correspondence Address: CONNOLLY BOVE LODGE & HUTZ, LLP, P O BOX 2207, WILMINGTON, DE, 19899, US

(73) Assignee: UNIVERSITY OF DELAWARE, Newark, DE

(21) Appl. No.: 10/621,727

(22) Filed: Jul. 17, 2003

Related U.S. Application Data
(60) Provisional application No. 60/396,319, filed on Jul. 17, 2002.

(51) Int. Cl. C08H 1/00

(52) U.S. Cl. 526/238.1

(57) ABSTRACT

The development of low dielectric constant materials from renewable resources such as plant oils and feathers is described in this invention. Soybean resin such as but not limited to, acrylated epoxidized soybean oil (AESO) and soybean oil pentaerythritol glyceride maleates (SOPERMA) is mixed with a reactive diluent such as but not limited to, styrene monomer. After that, various concentrations of chicken feather fibers or the fiber mats are mixed with the resin physically or using various process techniques such as resin transfer molding (RTM) and vacuum assisted resin transfer molding (VARTM) process. The mixtures are then free radically copolymerized at various temperatures to produce rigid composites. Surprisingly, the dielectric constants of the chicken feather composites are sufficiently low for electronic applications and lower than that of conventional semiconductor material such as silicon dioxide. Also, the mechanical properties of the composites are significantly enhanced with adding chicken feather fibers. The incorporation of the feather fibers gives rise to a considerable increase of stiffness of the soy oil-based composites. The density of the composites decreases with an increase of chicken feather fiber content.

### CLAIM FOR PRIORITY

The present application claims priority of U.S. Provisional Patent Application Serial No. 60/396,319, filed Jul. 17, 2002, the entire disclosure of which is herein incorporated by reference in its entirety.

### FIELD OF THE INVENTION

The present invention relates to the development of low dielectric constant materials from renewable resources plant oil such as soybean oils and animal feathers, such as chicken feathers. These new composites are affordable, natural, bio-based and environmentally friendly materials. The low dielectric constant, mechanical strength and low density of the developed composites are suitable for use in electronic applications.

### BACKGROUND OF THE INVENTION

The demand, for higher speed and miniaturization of the feature dimensions in the electronic products, has recently driven extensive studies to develop materials that possess low dielectric constants (K). Dielectric constant represents a material's capability to store electrical charge and measures the amount of alignment (or polarization) of the dipoles to the electric field. Loss factor is the amount of energy required to align dipoles or move ions. The low dielectric properties of heterogeneous polymer composites play an important role in device applications such as high performance capacitor, electrical cable insulation, electronic packaging and components. In the case of electronic packaging, one way to increase microchip's speed and to diminish power consumption and cross-talk effects is to decrease the dielectric constant of the insulator. The low dielectric constant and mechanical strength are attractive properties for the material to be used in electronic applications.

Developing low electric constant materials from renewable resources, such as plant oils and bird feathers is quite attractive. This would not only offer economic advantages since such raw materials are cheaper compared to the conventional dielectric materials, but also social advantages since their use contributes to global sustainability by not depleting the resources. These raw materials from renewable resources can substitute petroleum-based materials. Another major advantage of using plant oils and feathers brings about an environmental issue. Plant oil resins can be made to be biodegradable due to the presence of the fatty acid aliphatic chains that are susceptible to attack by lipase secreting bacteria. Consumption of poultry in the United States and elsewhere resulted in a substantial increase in feather waste products for disposal. Disposal of the feather waste is expensive and difficult. For example, poultry waste is burned or buried. These methods are environmentally unsound and restricted. A more expensive disposal method is a production of a low-quality protein animal feed for which demand is low nowadays. This invention offers a more environmentally benign solution for feather disposal, and presents to poultry producers the ability to reduce waste disposal costs and to gain a profit from feather waste.

This invention is not limited to chicken feathers and can be applied to any kinds of feathers. Soybean resin is based on triglycerides from soybean oil. Triglyceride oils can be derived from any plant oil such as linseed oil, rapeseed oil, cottonseed oil, corn oil, palm oil and canola oil. These new composites derived from plant oils and chicken feathers are natural, bio-based and environmentally friendly materials. Soybean oil is a low polarity material and feather fibers contain lots of air inside (hollow). The composite materials described herein have a low dielectric constant and structural stiffness comparable to those of other dielectric materials now in commercial use. These novel materials can be used in electronic device applications such as high-speed circuits, high performance capacitor, electrical cable insulation, electronic packaging and components. Such use includes but is not limited to the high volume composite utilization fields of automotive, farming equipment, civil infrastructure, defense aerospace, marine offshore, construction, bridge rehabilitation, etc.

Literature review shows that no invention is related to this invention, developing low dielectric constant materials from plant oils and chicken feathers. However the preparation of soybean resin and the free radical copolymerization of the resin with a reactive diluent such as styrene to form rigid composite materials with structural strength have been cited in U.S. Pat. No. 6,121,398 (“'398 patent”). This application and the '398 patent has Dr. Richard Wool as one of the inventors. The '398 patent disclosure is very relevant with respect to the teaching of high modulus polymers and composites from plant oils. The entire '398 patent is incorporated by reference in its entirety for all useful purposes. The '398 patent does not teach the use of features.

The U.S. Pat. No. 6,027,608 describes the processes for converting components of avian feather-waste stream to fabric fiber, protein and oil.

### SUMMARY OF THE INVENTION

This application relates to the preparation of new low dielectric composite materials from soybean oils and bird feathers using various mixing and molding techniques such as physical mixing, Resin Transfer Molding (RTM), Reaction Injection Molding (RIM), Vacuum Assisted Resin Transfer Molding (VARTM), Seeman's Composite Resin Infusion Manufacturing Process (SCRIMP), Atmospheric Pressure Molding (APM), open mold casting, spray-up, Sheet Molding Compound (SMC) Bulk Molding Compound (BMC), filament winding, pultrusion, prepregs, lamination and compression molding in order to improve mechanical properties of the final composites. The developed composites display low dielectric constants and enhanced properties that are comparable to the commercially successful dielectric materials. The dielectric constants of the composite materials are in the range of 1.7-2.7, measured at 25° C. and 100 Hz. These values are lower than that of the conventional SiO₂ insulator (about 4). These new materials derived from renewable resources are affordable, natural, bio-based and environmentally friendly materials containing plant oils and chicken feathers (“CF”) as major constituents. These materials should find commercial use since they offer low market prices and also social and environmental advantages.

### BRIEF DESCRIPTION OF THE FIGURES

FIG. 1 illustrates the dielectric constant of the room temperature (RT)-cured composites at a frequency of 100 Hz and a temperature of 25° C. as a function of feather fiber content.

FIG. 2 illustrates the frequency dependence of the dielectric properties of RT-cured AESO resin and CF mat at 25° C.

FIG. 3 illustrates the dielectric constants of the RT-cured composites as a function of temperature at a frequency of 100 Hz.

FIG. 4 illustrates the bulk density of RT cured AESO and SO:PER:MA composites as a function of feather fiber content.

FIG. 5 shows the storage modulus of the RT-cured AESO composites as a function of temperature.

FIG. 6 shows Tan δ of the RT-cured AESO composites measured by DMA as a function of temperature.

FIG. 7 shows SEM micrographs of the fractured surface of the AESO composite cured at elevated temperature.

### DETAILED DESCRIPTION OF THE INVENTION

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described. The examples illustrate representative products and are given by way of illustration only and are not to be considered as being limiting.

### Sample Preparation

### EXAMPLE 1

100 g of acrylated epoxidized soybean oil (AESO) was mixed with 50 g of styrene monomer. The free radical, chain growth copolymerization (or curing) reaction of AESO resin was carried out by thermal decomposition of the free radical initiators at elevated temperatures to make rigid composites. 1.5 wt % of tert-butyl peroxybenzoate (from Aldrich) was added as an initiator for curing. Various concentration of chicken feather fiber (CF, Tyson Foods Inc.) was added physically during mixing and the composites were molded in a silicon rubber mold. A high temperature curing of the composites was done at 90° C. for 2.5 hours and post-cured at 120° C. for 2 hours. After the total cure cycle was complete, samples were polished down for tests.

### EXAMPLE 2

AESO was mixed with 33 wt % of styrene monomer. After mixing, 3.0 wt % (for the total resin) of cumyl hydroperoxide (Trigonox 239A form Akzo Chemicals) was mixed as an initiator, and 0.8 wt % of cobalt naphthenate with 6% metal content (CoNap, from Witco) was added as an accelerator. 0, 5, 10, 20 wt % of chicken feather fiber was mixed physically and the composites were molded in a silicon rubber mold. Some composites, with higher (>20 wt %) concentrations of CF, were prepared by using a vacuum assisted resin transfer molding (VARTM) process using CF mats (Tyson Foods Inc.). CF mats were prepared by adding 3% of binder. The curing reaction was carried out by redox decomposition of the free radical initiators using a metal promoter at low temperatures. After room temperature curing for 24 hrs, the samples were post-cured at 120° C. for two hours.

### EXAMPLE 3

100 g of soybean oil pentaerythritol glyceride maleates (SO:PER:MA) was mixed with 50 g of styrene monomer. During mixing, 3 g of tert-butyl peroxybenzoate (Aldrich) were added as an initiator. Various concentrations of CF were added after mixing. A high temperature curing of the composites was done at 120° C. for 3.5 hours and post-cured at 150° C. for 1 hour.

### EXAMPLE 4

SO:PER:MA resin was mixed with 33 wt % of styrene monomer. 3.0 wt % (for the total resin) of methyl ethyl ketone peroxides (from Witco) was mixed as an initiator, and 0.8 wt % of cobalt naphthenate with 6% metal content (CoNap, from Witco) was added as an accelerator. Various concentrations of CF were added after mixing. Some composites, with higher (>20 wt %) concentrations of CF, were prepared by using a vacuum assistant resin transfer molding (VARTM) process using CF mats. After room temperature curing for 24 hrs, the SO:PER:MA samples were post-cured at 150° C. for one hour.

### Characterization

In dielectric analysis, a sample is placed between two gold electrodes, then a sinusoidal voltage is applied, creation an alternating electric field. This produces polarization in the sample, which oscillates at the same frequency as the electric field, but has a phase angle shift. This phase angle shift is measured by comparing the applied voltage to the measured current. The measured current is separated into capacitive (insulating) and conductive components, Dielectric constant (Permittivity, e′) and Loss factor (e″). The dielectric properties of the materials were measured on DEA 2970 Dielectric Analyzer (TA Instruments) with a heating rate of 2° C./min. The dimension of sample was 0.7 mm×25.4 mm×25.4 mm.

The storage modulus and glass transition temperature of the composites were measured using a Dynamic Mechanical Analyzer (DMA 2988, TA instruments) at a heating rate of 5° C./min. The dimension of the sample was 3 mm×10 mm×55 mm. Glass transition temperature was obtained from the maximum point of Tan Delta. The glass transition temperature of AESO itself is about 58° C.

The fracture toughness test was performed according to ASTM D5045 (three point bending mode) at room temperature. The dimension of the sample was 6.35 mm×12.70 mm×63.5 mm. The crosshead speed of a tester (Instroh 4201) was 1.27 mm/min (0.05 in/min). Fracture toughness and energy release rate were calculated from the raw data.

The dimension of sample for the flexural test was 3.17 mm * 12.70 mm * 63.5 mm. The flexural tests were performed according to ASTM D790 (three point bending mode) at room temperature. The crosshead speed of a tester (Instron 4201) was 1.27 mm/min (0.05 in/min).

The fracture surfaces of AESO composites were examined by scanning electron microscopy (SEM, JEOL JXA-840). The fracture surfaces were coated with gold using a sputter coater (Denton Vacuum Inc.).

### Results

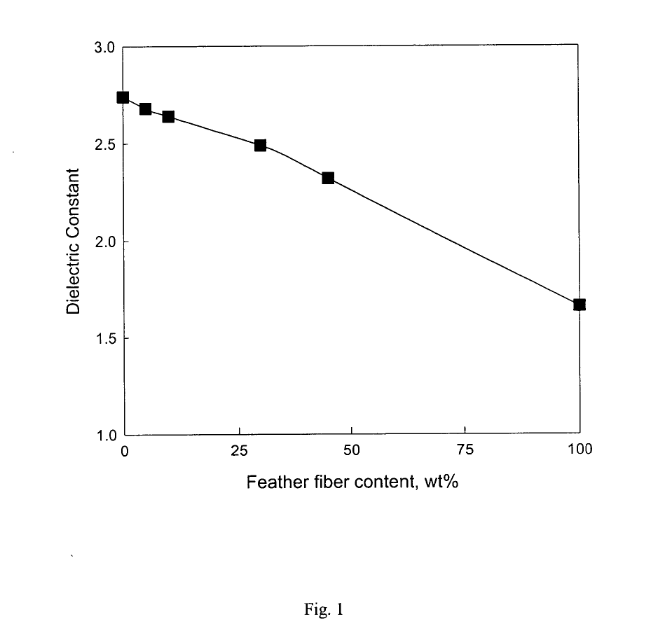

The dielectric properties of heterogeneous polymer composites play an important role in electronic applications such as high performance capacitor, electrical cable insulation, electronic packaging and components. FIG. 1 illustrates the dielectric constant of the room temperature cured composites at a frequency of 100 Hz and a temperature of 25° C. as a function of feather fiber content. The dielectric constants of the developed composites decrease, from 2.7 to 1.7, with an increase of chicken feather fiber content. The feather fiber is a low dielectric constant material, containing lots of air inside. The measured value of dielectric constant of CF mat was 1.673. Also, soybean oils are low polarity materials. For example, conventional semiconductor fabrication commonly uses silicon dioxide as a dielectric, which has a dielectric constant of about 4. The dielectric constant of epoxy is 4.1 and that of Teflon is about 1.9. The lowest possible or ideal dielectric constant is 1.0, which is the dielectric constant of a vacuum, whereas air has a dielectric constant of less than 1.001. Surprisingly, the dielectric constants of the developed chicken feather composites are sufficiently low for electronic applications and lower than that of conventional semiconductor materials. These newly developed novel composites are expected to increase microchip's speed and to reduce power consumption of circuits, and used in electronic applications.

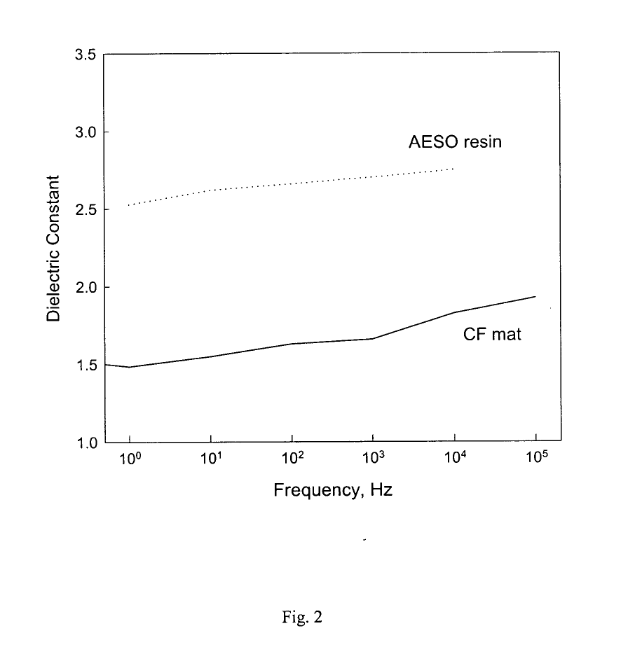

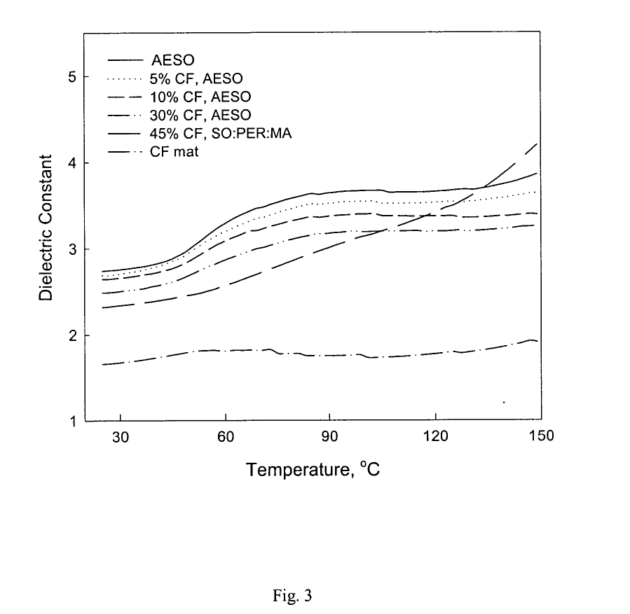

The frequency dependence of the dielectric properties of AESO resin at 25° C. is shown in FIG. 2. The dielectric constant is very little influenced by increasing frequency. When the applied frequency is low, the dipoles have enough time to move and they turn slowly. As the frequency of the applied field increases, the dipoles move faster, dissipating more energy, the dielectric constant may increase. FIG. 3 illustrates the dielectric constant of the composites as a function of temperature at a frequency of 100 Hz. The dielectric constant slightly increased with increasing temperature, resulting from the orientation of the dipoles when the composite softened with temperature.

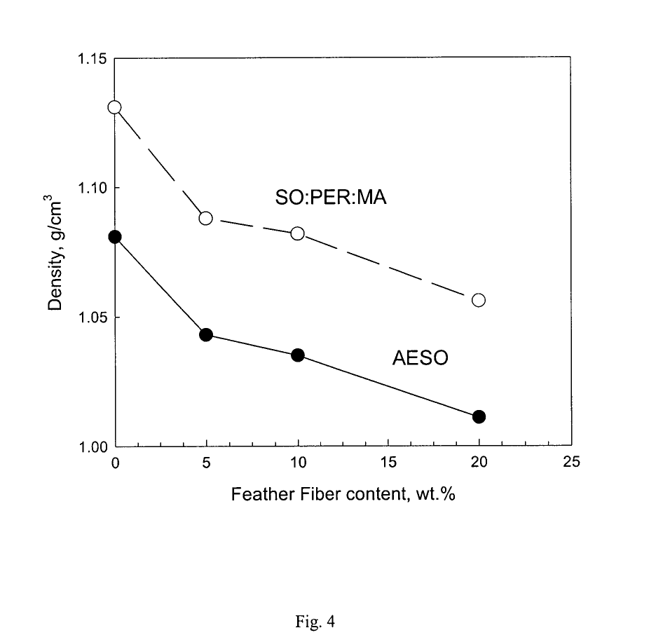

FIG. 4 illustrates bulk density of AESO and SO:PER:MA composites cured at room temperature. The density decreases with increasing feather fiber content. The density of chicken feather fiber is 0.796 g/cm³. They are very light materials having average diameter of 6 μm and length of 8 mm. The density of composite can be less than 1 g/cm³ at 28 wt % of CF content for AESO and at 39 wt % for SO:PER:MA from the calculated value. Lightweight materials make a significant impact on fuel consumption for automotive applications.

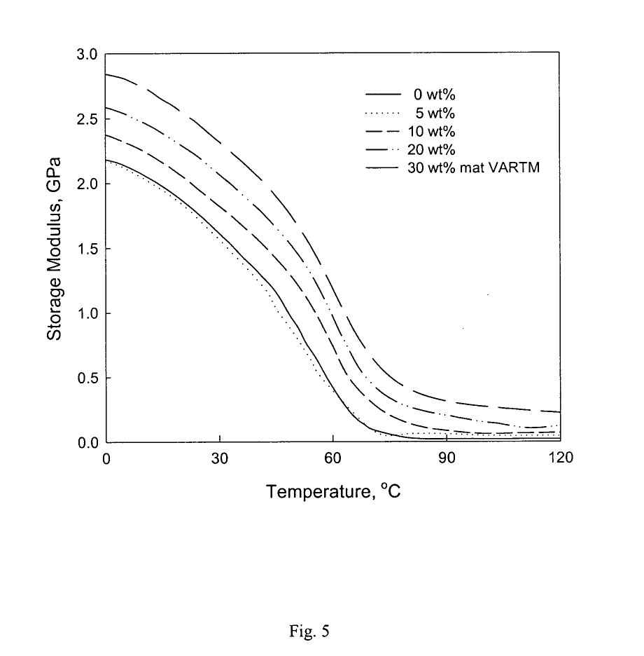

Dynamic mechanical measurements over a wide temperature range are useful in the understanding of the viscoelastic behavior and provide valuable insights into the relationship between structure, morphology and applicational properties of composite materials. FIG. 5 illustrates the storage modulus of room temperature cured AESO composites as a function of temperature. A change in the modulus indicates a change in rigidity and, hence, strength of the composite. The storage modulus of AESO composites was improved significantly with an adding chicken feather fiber over whole range of the testing temperature. The incorporation of chicken feather fiber gives rise to a considerable increase of stiffness of the soy oil based composites. The slight decrease at 5 wt % composite is due to voids remained in the composite.

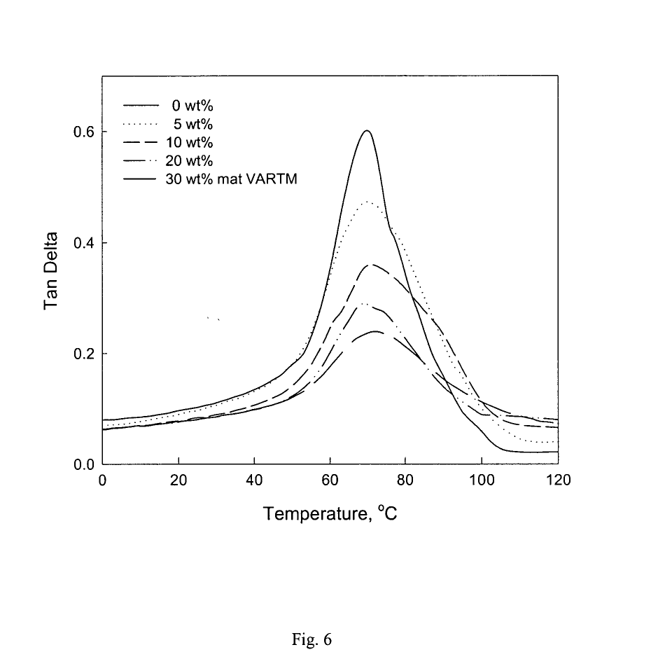

Tan δ of AESO composites versus temperature is shown in FIG. 6. The maximum value of the loss factors (Tan δ) decreases with increased feather fiber content indicating the increasing trend of composite rigidity. The lowering of the damping energy suggests the restraint effect of the fiber on the matrix mobility, and this restriction is enhanced with an increasing fiber content. Also, the damping peak becomes broader with increasing fiber content, indicating many kinds of relaxation modes of polymer chains due to the fiber. A peak of Tan δ is assigned to the glass transition temperature of AESO composites.

TABLE 1
Storage modulus and T_{g} of room temperature
cured AESO composites.

| | Storage Modulus at 40° C., | Glass Transition Temperature, |
|---|---|---|
| | GPa | ° C. |
| 0 wt% | 1.313 | 70 |
| 5 wt% | 1.291 | 70 |
| 10 wt% | 1.598 (+21.7%) | 71 |
| 20 wt% | 1.836 (+39.8%) | 70 |
| 30 wt%, | 2.085 (+58.8%) | 71 |
| VARTM | | |

TABLE 2
Storage modulus and T_{g} of room temperature cured
SO:PER:MA composites.

| | | Glass Transition |
|---|---|---|
| | Storage Modulus at 40° C., | Temperature, |
| | GPa | ° C. |
| SO:PER:MA | 1.039 | 128 |
| SO:PER:MA with 5% | 1.082 (+4.1%) | 129 |
| SO:PER:MA with 10% | 1.139 (+9.6%) | 128 |
| SO:PER:MA with 20% | 1.072 (+3.2%) | 127 |

Tables 1 and 2 represent the storage modulus at 40° C. and glass transition temperature of the AESO and SO:PER:MA composites, cured at room temperature, respectively . It is seen that the storage modulus of soybean resin was improved by adding chicken feather fibers. The storage modulus of 30 wt % AESO composite was improved 58.8% in comparison. The glass transition temperature was not very much influenced by the fiber content, so the interaction between AESO resin and feather fiber does not seem very strong.

Fracture toughness and flexural properties were measured to study the effect of concentration of chicken feather fibers on the mechanical properties of the composites.

TABLE 3
Fracture toughness properties of high temperature
cured AESO composites.

| | | | Energy |
|---|---|---|---|
| | Max. Load | Fracture Toughness | Release rate |
| | N | K_{ic}, MPa m^{1/2} | Gi_{ic},J/m² |
| AESO w/o fiber | 114.3 | 0.859 | 151 |
| AESO with 5 wt % | 121.0 | 0.923 (+7.5%) | 197 (+30.5%) |
| AESO with 10 wt % | 126.4 | 0.968 (+12.7%) | 198 (+31.1%) |
| AESO with 20 wt % | 126.6 | 0.971 (+13.0%) | 168 (+11.3%) |

TABLE 4
Fracture toughness properties of RT cured SO:PER:MA composites.

| | Max. | | Energy |
|---|---|---|---|
| | Load | Fracture Toughness | Release rate |
| | N | K_{ic}, MPa m^{1/2} | G_{ic}, J/m² |
| SO:PER:MA | 26.9 | 0.204 | 6.3 |
| SO:PER:MA with 5% | 32.9 | 0.242 (+18.6%) | 14.8 (+134.9%) |
| SO:PER:MA with 10% | 45.4 | 0.340 (+66.7%) | 34.0 (+439.7%) |
| SO:PER:MA with 20% | 51.3 | 0.384 (+88.2%) | 51.5 (+717.5%) |

Tables 3 and 4 show fracture toughness and energy release rate of AESO and SO:PER:MA composites, respectively, with various concentration of chicken feather fiber. The fracture toughness and energy release rate are greatly improved with an increase of feather fiber concentration.

TABLE 5
3/30 Flexural properties of high temperature cured AESO composites.

| | | Flexural Modulus |
|---|---|---|
| Flexural Yield Strength, | | of Elasticity, |
| MPa | | GPa |
| AESO w/o fiber | 45.623 | 1.094 |
| AESO with 5 wt % | 42.125 (−7.7%) | 1.392 (+27.2%) |
| AESO with 10 wt % | 47.768 (+4.7%) | 1.669 (+52.6%) |
| AESO with 20 wt % | 39.215 (−14.0%) | 1.488 (+36.0%) |

TABLE 6
Flexural properties of RT cured SO:PER:MA composites.

| | | Flexural Modulus |
|---|---|---|
| | Flexural Yield Strength, | of Elasticity, |
| | MPa | GPa |
| SO:PER:MA | 26.979 | 1.029 |
| SO:PER:MA with 5% | 25.168 (−6.7%) | 1.112 (+8.1%) |
| SO:PER:MA with 10% | 31.682 (+17.4%) | 1.736 (+68.7%) |
| SO:PER:MA with 20% | 26.400 (−2.1%) | 1.078 (+4.8%) |

Tables 5 and 6 give flexural yield strength and flexural modulus of elasticity of the AESO and SO:PER:MA composites, respectively, with various concentrations of chicken feather fiber. In these tests, the flexural modulus of elasticity was improved significantly with adding chicken feather fibers. However, the improvement was not dependent on the fiber content. The flexural strength was fluctuated with the fiber content. From the results, it can be concluded that chicken feather fiber has a positive influence on improving the mechanical properties of soybean oil based composites. Also, the mechanical strengths of the developed composites are attractive properties for electronic applications.

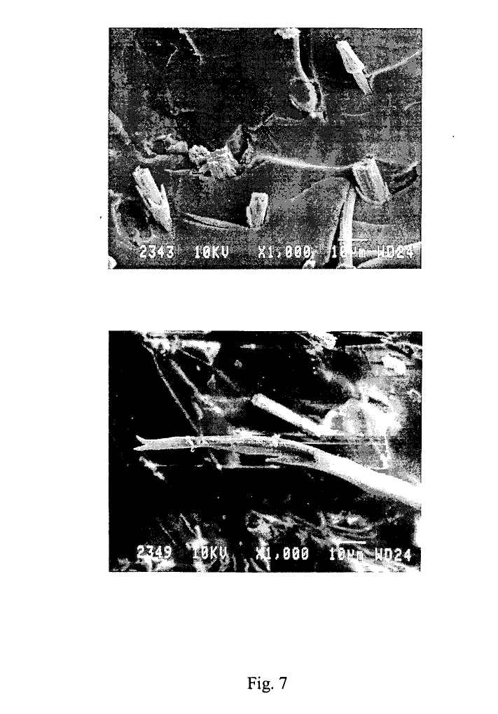

FIG. 7 illustrates SEM micrographs of the fractured surface of the AESO composite cured at high temperature. It is seen that the chicken feather fibers in the composite were broken, not pulled out, during fracture indicating that the adhesion between AESO resin and chicken feather is relatively strong. Also, the feather fiber in the composite is still hollow containing air inside. The hollow fiber or the presence of air would be thought to be a reason of low dielectric constant of the composites.

All the references discussed in this application are incorporated by reference in their entirety for all useful purposes.

We claim:

1. A low dielectric constant material comprising a plant oil and animal feathers.

2. The material as claimed in claim 1, wherein said plant oil is soybean oil and said animal feathers are fiber feathers.

3. The material as claimed in claim 1, wherein said oil is a triglyceride.

4. The material as claimed in claim 1, wherein said feathers are chicken feathers.

5. The material as claimed in claim 1, wherein said feathers are feather mats.

6. The material as claimed in claim 2, wherein said fibers are natural fibers.

7. A process to produce a low dielectric constant material which comprises mixing feathers and copolymerizing with a radically reactive monomer selected from the group consisting of styrene, methyl methacrylate, divinyl benzene and ethylene glycol dimethacrylate to form a rigid composite.

8. The process as claimed in claim 7, further comprising curing with a free radical initiator.

9. The process as claimed in claim 8, further comprising curing said with a free radical initiator with a metal promoter.

10. The process as claimed in claim 7, further comprising curing at an elevated temperature.
